(19) United States
(12) Patent Application Publication
(10) Pub. No.: US 2007/0069684 A1
(43) Pub. Date: Mar. 29, 2007

(54) Light pad charger for electronic devices

(76) Inventor: Martin H. Ramsden, NE Lawrenceville, GA (US)

Correspondence Address: MOTOROLA INC, 600 NORTH US HIGHWAY 45, ROOM AS437, LIBERTYVILLE, IL, 60048-5343, US

(21) Appl. No.: 11/236,999

(22) Filed: Sep. 28, 2005

(51) Int. Cl. H02J 7/00

(52) U.S. Cl. 320/101

(57) ABSTRACT

A light emitting charger is provided. The light emitting charger delivers light energy to a portable electronic device having a rechargeable battery. The electronic device is equipped with a photovoltaic energy conversion device that converts the transferred light into an electrical current that can be used to charge the battery. Through alternate communication mechanisms, the electronic device can alert the charger as to when to illuminate the light sources and which light sources to illuminate. The charger is equipped with photo detectors for receiving photo communication from the electronic device. In one embodiment, the charger periodically pulses one or more light sources until it receives light reflected from reflective material disposed along the electronic device. When the reflective light is received, the charger may actuate a plurality of light sources in a predetermined pattern corresponding to the amount or location of the reflective light. In another embodiment, the electronic device is equipped with a photo communication light source, and may communicate with the charger through pulsed light.

### TECHNICAL FIELD

This invention relates generally to chargers for electronic devices, and more particularly to a light-emitting charger for contactlessly charging portable electronic devices.

### BACKGROUND ART

People can be seen with portable electronic devices everywhere. From home to office, from restaurants to sporting events, it seems that almost everyone carries one, or more, portable devices. By way of example, the mobile telephone, once a luxury for the very wealthy, is now quite commonplace. According to the Cellular Telecommunications and Internet Association (CTIA), in 2004 over 182 million people, in the United States alone, used mobile telephones.

Mobile telephones and other devices owe their portability to rechargeable batteries. It is the rechargeable battery that allows the user to move about the world without being tethered to a power outlet. While today's rechargeable batteries may deliver five or more hours of talk time, once their stored energy becomes depleted, they must be recharged. In short, when the battery dies, the user must charge it.

The traditional way to charge a rechargeable battery is by connecting a power supply cable to the device itself. A power supply, which may plug into a traditional wall outlet, generally includes a power cord with a device specific connector. The user plugs the power supply into the wall, and plugs the device specific connector into the electronic device. Power is then reliably transferred from the outlet to the device.

The problem with this traditional method is that some users, in today's hustle and bustle world, find that plugging the device specific connector into the device is time consuming and sometimes tedious. They would rather be able to drop the device on a desk and have it charge automatically.

To address this concern, some manufacturers have begun to develop contactless, inductive chargers. In these chargers, a transformer is essentially split in half, with the primary residing in a charging station and the secondary residing in the electronic device. When the primary and secondary come into close proximity, provided they are aligned properly, an electromagnetic field couples the primary and secondary to transfer power.

The problem with these inductive chargers is twofold: First, the primary and secondary must be precisely aligned for maximum coupling, and thus maximum charging efficiency. A slight misalignment can greatly reduce the overall efficiency. Second, the electromagnetic field is generally emitted uniformly, causing it to not only couple to the secondary, but to other objects as well. This stray coupling can compromise the energy transfer. By way of example, if the inductive charger is placed on a metal table, some of the electromagnetic field will be transferred to the table. This energy is wasted.

There is thus a need for an improved contactless charger to allow users to conveniently charge their portable electronic devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a contactless charger in accordance with the invention.

FIG. 2 illustrates, graphically, one method for a charger in accordance with the invention detecting the presence of an electronic device.

FIG. 3 illustrates one example of a charger in accordance with the invention actuating a subset of light sources in a predetermined pattern corresponding to the characteristics of an electronic device.

FIG. 4 illustrates another embodiment of a contactless charger in accordance with the invention.

FIG. 5 illustrates one embodiment of an electronic device in accordance with the invention.

FIG. 6 illustrates one embodiment of a lens array for use with a charger in accordance with the invention.

FIGS. 7-8 illustrate alternate methods of communication in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be noted that the embodiments reside primarily in combinations of method steps and apparatus components related to a light pad for charging rechargeable batteries used to power electronic devices. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional microprocessors or controllers and unique stored program instructions that control the microprocessors to implement, in conjunction with certain non-processor circuits, some, most, or all of the functions of the light pad charger described herein. The non-processor circuits may include, but are not limited to, charging circuitry, memory circuits, power conversion circuits, signal drivers, clock circuits, power source circuits, and user input devices. As such, these functions may be interpreted as steps of a method to perform charging of rechargeable batteries. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and microprocessors with minimal experimentation.

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” As used herein, “light” refers to any frequency of the electromagnetic spectrum capable of being converted to current by a photovoltaic device.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

A contactless charger is provided that uses light to transfer energy from the charger to an energy storage device, like a rechargeable battery coupled to a portable electronic device for instance. The electronic device is equipped with a photovoltaic energy conversion device, like a rigid or flexible solar cell for example. When the electronic device is placed on the contactless charger, the charger projects light from its surface. The photovoltaic energy conversion device then receives the light, converts it into electrical current, and thereby charges the battery.

To keep the charging surface from being illuminated continuously, various embodiments described herein use techniques to provide information from the electronic device to the charger. In one embodiment, the charger periodically, briefly illuminates one or more light sources to detect the presence of an electronic device. The electronic device to be charged includes reflective material disposed across the surface of the device. When the periodically pulsed light is reflected off the reflected material, photo detectors disposed within the charger detect this reflected light. The charger may then illuminate a subset of its light sources in a pattern corresponding to the information received from the reflected light. By way of example, where the reflective material is placed along the outer edges of the electronic device, the charger may elect to only actuate those light sources that fall within a perimeter set forth by the reflective material.

In another embodiment, the electronic device may in fact include an electronic device communication light source. This light source may communicate photo information indicating, for example, how bright the light sources should be and which ones should be illuminated.

In yet another embodiment, a lens may be incorporated into either the electronic device or the charger. The lens or lens array then concentrates and/or directs light upon the photovoltaic energy conversion device such that the overall efficiency of the system may be increased.

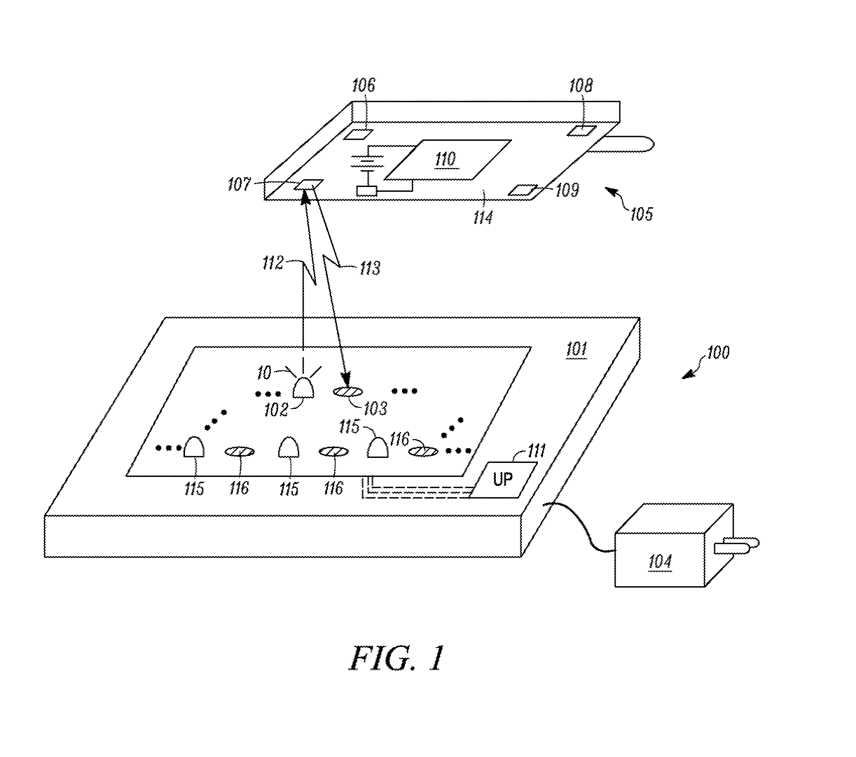

Turning now to FIG. 1, illustrated therein is one embodiment of a battery charger 100 in accordance with the invention. The charger 100 includes a first surface 101 upon which an electronic device 105 may be placed. The battery charger 100 includes at least one light source 102 that is capable of projecting light 10 from the first surface 101. Note that this light source 102 can include a plurality of light sources 115 disposed across the surface 101 of the charger 100. Examples of suitable light sources include conventional light bulbs, light emitting diodes, lasers, laser diodes, infrared lamps, ultraviolet lamps, and combinations or equivalents thereof. The term “project” is used herein to refer to the emission of light from one or more of the light sources 115. As one embodiment of the invention includes a planar surface, the term “project” will indicate emission of light outward from the planar surface. It will be clear to those of ordinary skill in the art having the benefit of this disclosure, however, that the invention is not so limited. Other non-planar shapes may be equivalently substituted. For alternate shapes, the term “project” should indicate the emission of light towards the electronic device.

The charger 100 also includes at least one photo detector 103 capable of receiving reflected light 113 from the electronic device 105. There are several examples of photo detectors suitable for the invention available on the market, including photovoltaic sensors, photo diodes, photo transistors, chip photo sensors, and IRdA photo sensors. Examples of suitable photo detectors include the TEMDS family of photo diodes manufactured by Vishay, the BP family of photo transistors manufactured by Vishay, the TPS family of photo sensors manufactured by Toshiba, and the RPI family of photo transistors manufactured by Rohm. Additionally, infrared sensors may also be employed, including the RPM family of infra-red communication devices manufactured by Rohm. Note that the term “photo detector” is used to refer to detectors that sense electromagnetic radiation, regardless of whether it falls within the visible spectrum. While most devices receive light, infra-red and ultraviolet detectors by way of example, may also be used.

As with the light source 102, the photo detector 103 may in fact include a plurality of photo detectors 116 disposed across the surface 101 of the charger 100. A power supply 104 may be included to supply power from a source such as a wall outlet to the charger 100.

As mentioned above, to conserve energy, it is sometimes desirable to have the light source(s) 102 not stay continuously illuminated. Where this is the case, the charger 100 includes a control mechanism, which may be executed by an optional microprocessor or controller 111, to selectively actuate the light source(s) 102.

In a first embodiment, light source 102 periodically projects light 112 from the surface 101 of the charger 100. This periodic projection occurs while the photo detector 103 fails to receive reflected light 113 from the electronic device 105. There is no reflected light 113 as long as the electronic device 105, which may include reflective material 107, is not in proximity with the charger 100.

Note that the preceding paragraph refers to “reflected light.” It will be clear to those of ordinary skill in the art that when the charger 100 is placed in a lighted room, there is a threshold of ambient light the photo detectors 103 receive. For the photo detectors 103 that receive reflected light, their signals will be at a higher level than those receiving only ambient light. As such, the photo detectors 103 may be configured such that when an amount of light greater than the ambient by a predetermined threshold is received, this is to be interpreted as reflected light. For example, where a first photo detector receives 0.5 foot candles of additional light when compared to a second photo detector, the charger 100 will interpret that increased amount of light as reflected light.

It will be clear to those of ordinary skill in the art having the benefit of this disclosure, however, that the invention is not so limited. Rather than using a predetermined amount of additional light, other substitute detection thresholds may be used. For instance, a particular color or wavelength may be detected. Also, a particular shape or duration of light may also alert the charger that reflected light has been received by particular photo detectors.

Once the electronic device 105 is placed on the surface 101 of the charger 100, the projected light 112 will be reflected from reflective material 107 disposed along the surface 114 of the electronic device 105. Whenever the photo detector 103 receives reflected light 113 from the light source 102, i.e. reflected light 113 that has been reflected from the reflective material 107 on the electronic device 105, the light source 102 continues to emit light.

Said another way, the light source 102 periodically illuminates so as not to stay continuously on, so as to actuate the light source 102 for extended periods only when the electronic device 105 is resting on the surface 101 of the charger 100. Whenever this illuminated light 112 is reflected back to the photo detector 103, the charger 100 knows that the electronic device 105 is present on its surface 101. As such, it causes the light source 102 to continue to emit light.

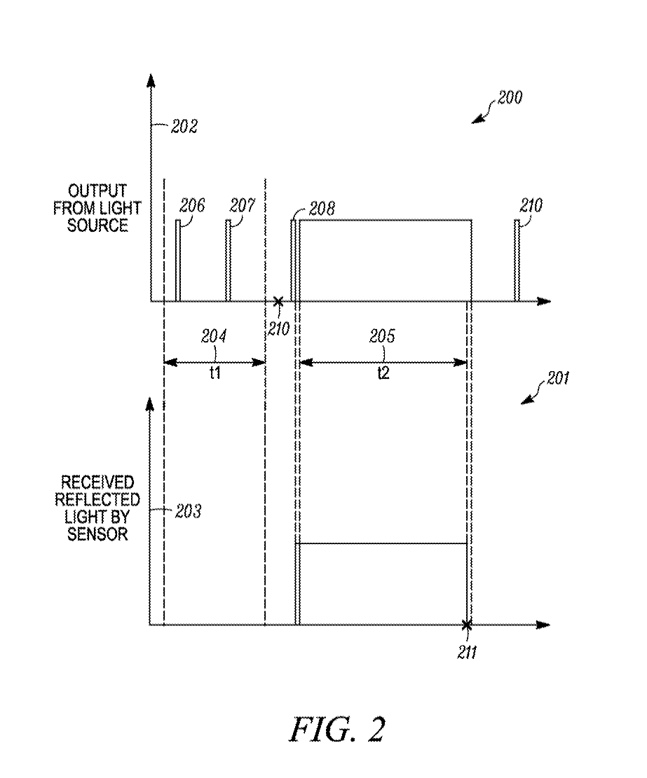

This pulsed mode of actuating the light sources may be more clearly seen in FIG. 2. Turning briefly to FIG. 2, illustrated therein are two graphs 200,201. Graph 200 shows the light output from the light source(s) along axis 202, while graph 201 shows light received by the photo detector(s) along axis 203.

During the period t1 204, there is no electronic device on the top surface of the charger. As such, the projected, periodic light pluses 206,207 do not get reflected back to the photo detector. Thus, the charger periodically continues to pulse, essentially “looking” for an electronic device to charge.

At time 210, an electronic device is placed upon the surface of the charger. The next pulse of light 208 is therefore reflected off of the reflective material, and is received by the photo detector as indicated at 209. Now the charger knows that an electronic device is sitting on its surface. Thus, it continuously illuminates the light source during time t2 205, which represents the amount of time that the photo detector is receiving reflected light. In other words, while the photo detector receives light from the light source that has been reflected from the electronic device, the light source continues to emit light. At time 211, the electronic device is removed. The charger then begins emitting periodic pulses again 210.

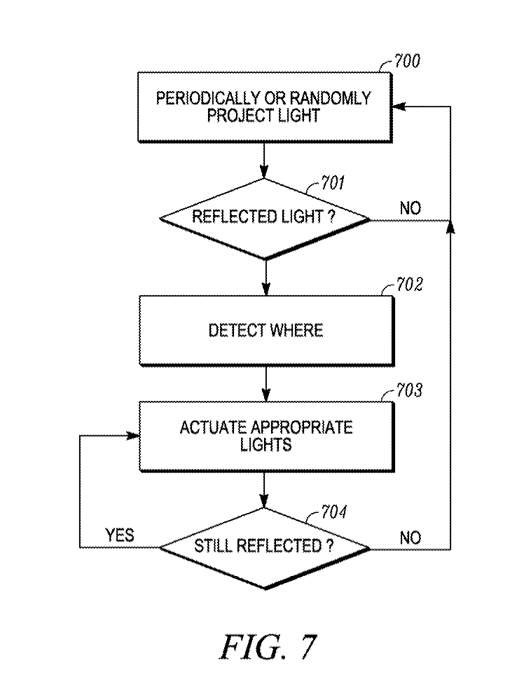

This method is outlined in a flow chart in FIG. 7. Turning briefly to FIG. 7, at step 700, the charger periodically pulses, looking for an electronic device. At decision 701, the charger determines whether there is reflected light. If so, the charger determines where at step 702. The charger then illuminates the appropriate lights at step 703, and determines whether the device is still present at decision 704.

Turning back to FIG. 1, as noted above, the light source 102 may comprise a plurality of light sources 115 disposed across the surface 101 of the charger 100. Similarly, the photo detector 103 may in fact include a plurality of photo detectors 116 disposed across the surface 101 of the charger. In some environmental situations, when an electronic device 105 is placed on the surface 101, it is desirable only to actuate those light sources that will couple light to the photovoltaic conversion device 110 in the electronic device 105. One such example would be in a dark room where people are sleeping. They may not want a lot of stray light projecting from the pad.

In one embodiment, the charger 100 accomplishes this by detecting multiple pieces of reflective material 106-109. Where either multiple pieces 106-109 (or a continuous section that circumscribes the perimeter of the electronic device 105) are present, the charger 100 is able to detect the overall shape of the device 105 by detecting just where projected light is reflected. Once this shape is known, the charger may illuminate only those lights that fall within this perimeter.

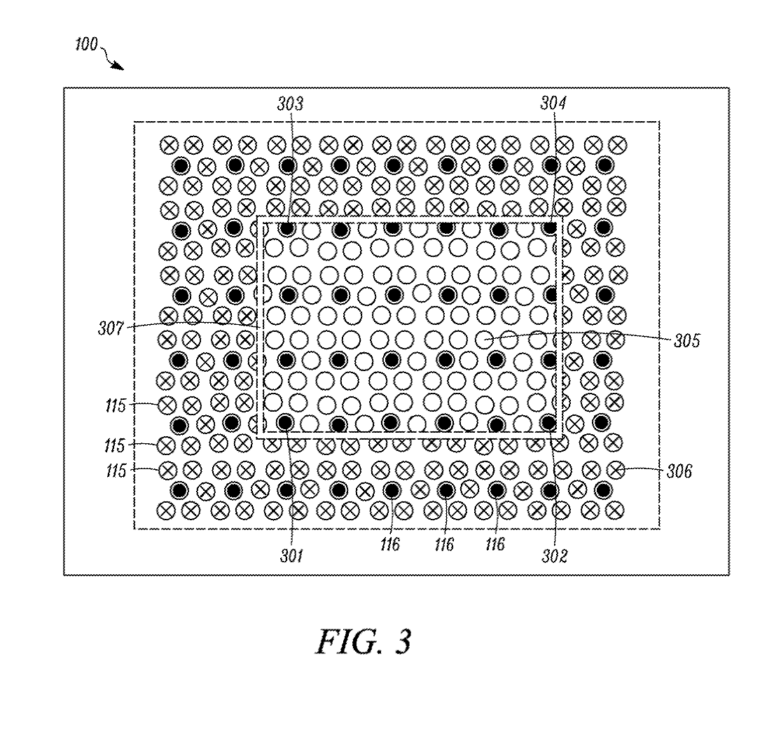

Turning briefly to FIG. 3, illustrated therein is such an illuminated pad. Where the plurality of light sources 115 periodically projects light from the surface 101 of the charger 100 to detect the presence of an electronic device, and the plurality of photo detectors 116 receive light reflected off the reflective material (106-109 in FIG. 1) when the device is present, the battery charger causes a subset 305 of the plurality of light sources 115 to project light. The subset 305 corresponds to a predetermined pattern associated with the amount, and/or location, of light reflected from the reflective material.

Continuing the example set forth in FIG. 1, in FIG. 3 the charger 100 detects reflected light with photodetectors at points 301-304. This reflected light becomes a “photo communication”, in that it relays geometric and placement information to the charger 100. From this plurality of points, the charger 100 is able to determine the outer perimeter 307 of the device. Thus, the charger 100 turns on the lights 305 that fall within this perimeter 307. The remaining lights 306 remain off.

Note that this is just one method for the charger to determine the shape of the device. It will be clear to those of ordinary skill in the art having the benefit of this disclosure that the invention is not so limited. Another method would be to employ a single piece of reflective material, where the single piece has varying shapes or sizes. For instance, a small square may represent predetermined pattern 1, while a medium circle may represent predetermined pattern 2, and so forth.

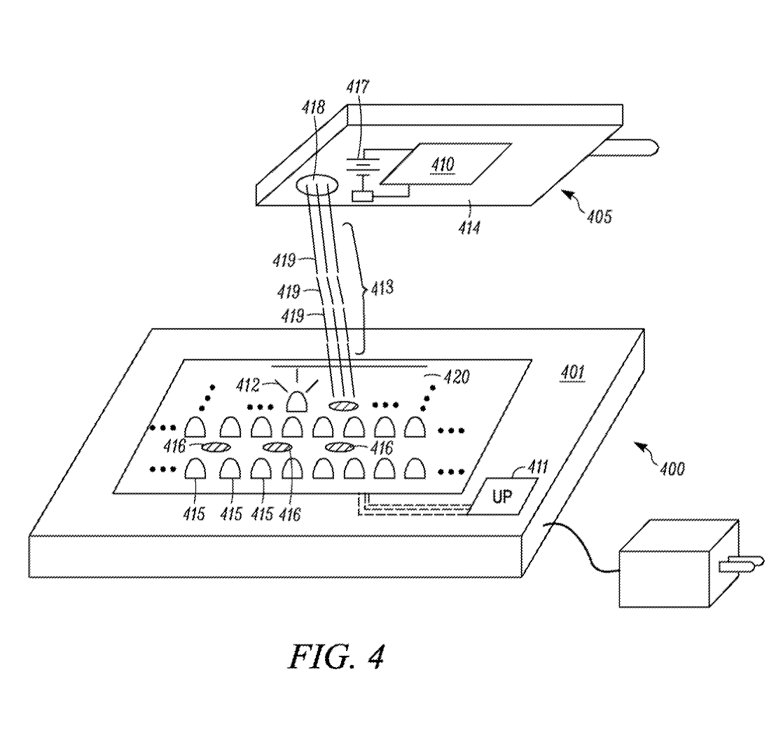

Turning now to FIG. 4, illustrated therein is an alternate embodiment of the invention. In the embodiment of FIG. 4, a system for charging a rechargeable battery 417 is shown. The system includes a portable electronic device 405 with a rechargeable battery 417 coupled thereto. The portable electronic device 405 includes a photovoltaic conversion device 410 for converting received light into electrical current. This photovoltaic conversion device 410 may be a rigid device, like a gallium-arsenide solar cell, or may be flexible. It may even be disposed on the exterior of the housing 414, for example with an amorphous silicon paint or spray.

A light-emitting charger 400 is provided. The light-emitting charger 400 includes a planar surface 401 for supporting the portable electronic device 405. The light-emitting charger 400 further includes at least one light source (shown illustratively herein as a plurality) 415 capable of emitting light 412 from the planar surface 401 towards the portable electronic device 405, as well as at least one photo detector (shown illustratively herein as a plurality) 416 capable of receiving light 413 from the planar surface 401. The charger includes a controller 411 capable of selectively actuating any of the light sources 415. The controller 411 actuates the light sources and continues to do so as long as any of the photo detectors 416 receive photo information from the planar surface 401.

In the embodiment of FIG. 4, rather than relying on reflected light as with FIGS. 1-3, the electronic device 405 is equipped with a communication light source 418 capable of transmitting informational messages 419 through pulses of light. When the electronic device 405 comes in close proximity with the charger 400, the communication light source 419 emits an informational message 419. This informational message 419, or photo communication, may include geometric information about the electronic device 405.

When any of the photo detectors 416 receives the informational message 419 from the portable electronic device 405, the controller 411 actuates the light sources 415. Where the informational message 419 includes information about the size or shape of the portable electronic device 405, selective light sources may be actuated. When the light source 415 includes a plurality of light sources, and when the photo detectors 416 receive the informational message 419 from the portable electronic device 405, the controller 411 illuminates a subset 420 of the light sources 415 as directed by the informational message 419.

Note that where the electronic device 405 includes both the communication light source 408 and the photovoltaic conversion device 410, as shown, the device 405 has the ability to communicate with the charger 400. Now a greater bandwidth of information is available between the charger 400 and the device 405. A data communication scheme can be developed to allow the device 405 to control the charger's light sources 415. In such, the device 405 may become the master while the charger 400 is the slave, or vice versa.

The charger 400 may receive various types of information from the electronic device 405. Using the light sources 415, the charger 400 may communicate this information to a user. An example would be for the device 405 to transmit charging information to the charger 400, and for the charger 400 to display the charge status of the battery 417 to a user.

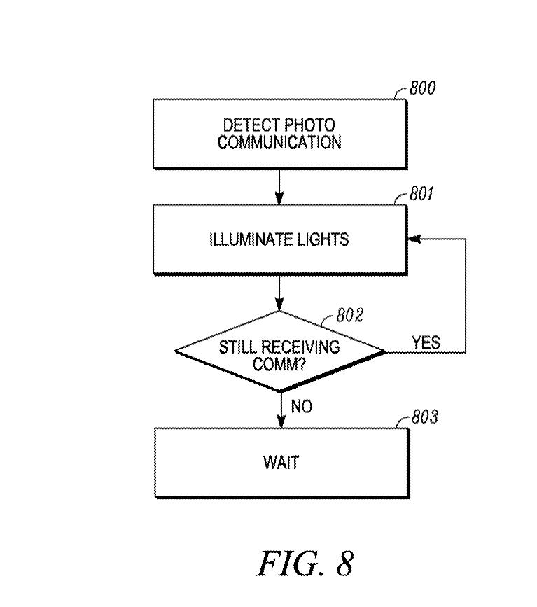

A method for this communication scheme is illustrated in FIG. 8. Turning briefly to FIG. 8, to recap the steps, the charger detects communication from the device at step 800. The charger illuminates the appropriate lights at step 801. Using decision 802, the charger continues to do so while there is communication, be it continuous or intermittent. When communication ceases, the charger waits for new communications at step 803.

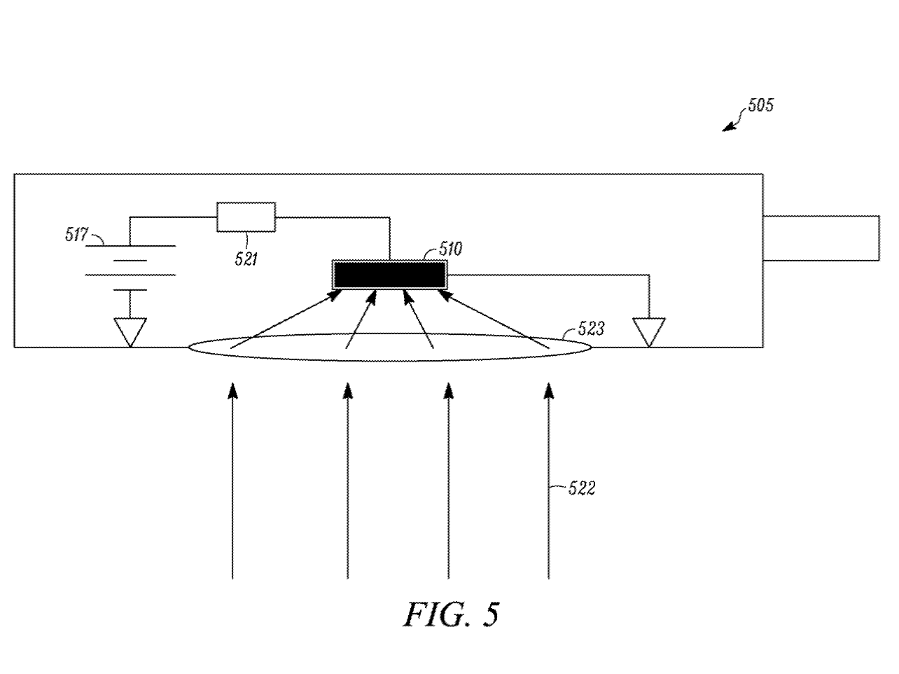

Turning now to FIG. 5, illustrated therein is one embodiment of an electronic device 505 in accordance with the invention. In this embodiment, the electronic device includes both a photovoltaic conversion device 510 and a rechargeable battery 517 coupled thereto. Charging or protection circuitry 521 may also be included.

To increase the efficiency of the photo charging, the electronic device 505 is equipped with a lens 523. The lens 523 concentrates the incident light 522, thereby directing it to the photovoltaic conversion device 510. Additionally, the lens 523 allows a designer to set the focal length equal to the distance between the charger 500 and the photovoltaic device, thereby increasing the luminous flux delivered to the photovoltaic device. This concentration of incident light 522 allows the designer to reduce the size of the photovoltaic device without compromising charging efficiency.

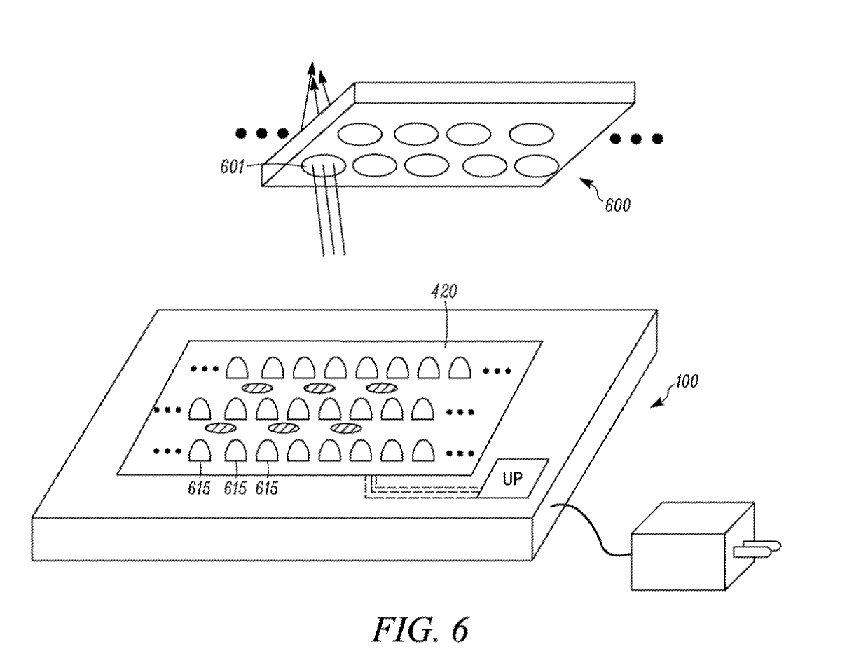

Likewise, to improve the efficiency of the charger, turning now to FIG. 6, an array of lenses 600 may be placed over the light sources 615. This array of lenses 600 may be a transparent plastic sheet honey-combed with lens pockets 601 that align with the light sources 615. Alternatively, individual lenses may snap on the light sources 615.

To recap, described herein is a battery charger for contactless recharging of rechargeable batteries. In one embodiment, the charger is a light pad and includes both a plurality of light sources and a plurality of photodetectors (that may be dispersed among the light sources) disposed across a surface of the charger. A mircoprocessor or controller, capable of actuating the light sources, may be included.

When any of the photo detectors receive a photo communication, which may either be reflected light from reflected material disposed along at least one portion of the surface of the electronic device or photo information delivered from light source on the electronic device, the microprocessor actuates the light sources. The receipt of information indicates that an electronic device with a rechargeable battery coupled thereto has been placed on the charger.

In one embodiment where reflective material on the electronic device is employed, the microprocessor periodically actuates at least one of the plurality of light sources. When an electronic device is present on the surface of the charger, and when the electronic device includes reflective material, the periodically pulsed light will be reflected back to the charger as a photo communication. When the microprocessor periodically actuates at least one of the plurality of light sources, and where the photo communication is reflected light from the reflective material disposed along the surface of the electronic device, the microprocessor may actuate a subset of the plurality of light sources. The subset may correspond to a predetermined pattern associated with the pattern or placement of the reflective material.

In an alternate embodiment, where the electronic device includes a communication light, the device can communicate a variety of information to the charger, including size, shape, intensity of light, and even which lights to turn on and off.

In the foregoing specification, specific embodiments of the present invention have been described. While the specific embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, one embodiment above used a plurality of reflectors disposed about the perimeter of the electronic device to determine the geometry of the device. A variation in this detection would be to use a central reflector dot on the device and have a pre-determined light transmitter area defined in the pad, around this reflector. Another variation would be to have a reflector dot pattern or bar code scheme that could contain much more information when decoded by the charger. The photo information may include the geometry of the pattern, the intensity of transmitters, the time transmitters are on, and so forth. Additionally, the pad may include a pressure sensor for detecting the presence of the electronic device.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A battery charger, comprising:
a. a first surface upon which an electronic device may be placed;
b. at least one light source capable of projecting light from the first surface;
c. at least one photo detector capable of receiving light reflected from the electronic device; and
d. a power supply coupled to the charger;
wherein while the at least one photo detector receives light from the at least one light source that has been reflected from the electronic device, the at least one light source continues to emit light.

2. The battery charger of claim 1, further comprising the electronic device, wherein the electronic device comprises a reflective material disposed along a surface of the electronic device.

3. The battery charger of claim 2, wherein the at least one light source periodically projects light from the first surface when the at least one photo detector does not receive light from the at least one light source that has been reflected from the reflective material.

4. The battery charger of claim 3, wherein the at least one light source comprises a plurality of light sources disposed across the first surface, further wherein the at least one photo detector comprises a plurality of photo detectors disposed across the first surface.

5. The battery charger of claim 4, wherein when the plurality of light sources periodically projects light from the first surface and any of the plurality of photo detectors receives light reflected from the reflective material, the battery charger causes a subset of the plurality of light sources to project light, the subset corresponding to a predetermined pattern associated with an amount of light reflected from the reflective material.

6. A light pad for charging rechargeable batteries, the light pad comprising:
a. a plurality of light sources;
b. a plurality of photo detectors dispersed among the plurality of light sources; and
c. a microprocessor capable of actuating any of the plurality of light sources;
wherein when any of the plurality of photo detectors receives a photo communication from an electronic device, the microprocessor actuates a subset of the plurality of light sources.

7. The light pad of claim 6, further comprising a surface upon which the electronic device, having a rechargeable battery coupled thereto, may be placed.

8. The light pad of claim 7, wherein the microprocessor periodically actuates at least one of the plurality of light sources.

9. The light pad of claim 8, wherein when the microprocessor periodically actuates the at least one of the plurality of light sources and the photo communication comprises reflected light from a reflective material disposed along a surface of the electronic device, the microprocessor actuates a subset of the plurality of light sources, the subset corresponding to a predetermined pattern associated with the reflective material.

10. The light pad of claim 9, wherein any of the plurality of light sources are selected from the group consisting of light bulbs, light emitting diodes, lasers, laser diodes, infrared lamps, ultraviolet lamps, and combinations thereof.

11. A system for charging a rechargeable battery, the system comprising:
a. a portable electronic device having the rechargeable battery coupled thereto; and
b. a light emitting charger, the light emitting charger comprising:
i. a planar surface for supporting the portable electronic device;
ii. at least one light source capable of emitting light from the planar surface towards the portable electronic device;
iii. at least one photo detector capable of receiving light from the planar surface; and
iv. a controller capable of selectively actuating the at least one light source;
wherein the controller actuates the at least one light source and continues to do so as long as the at least one photo detector receives photo information from the planar surface.

12. The system of claim 11, wherein the portable electronic device comprises a reflective material disposed along at least one portion of a surface of the electronic device.

13. The system of claim 12, wherein the at least one light source comprises a plurality of light sources disposed along the planar surface, further wherein the at least one photo detector comprises a plurality of photo detectors disposed along the planar surface.

14. The system of claim 13, wherein when the controller actuates any of the plurality of light sources and light reflected from the reflective material is received by any of the plurality of photo detectors, the controller causes a subset of the plurality of light sources to actuate, the subset comprising a predetermined configuration corresponding to an amount of light reflected from the reflective material.

15. The system of claim 11, wherein the portable electronic device comprises a communication light source capable of transmitting informational messages.

16. The system of claim 15, wherein when the at least one photo detector receives an informational message from the portable electronic device, the controller actuates the at least one light source.

17. The system of claim 16, wherein the at least one light source comprises a plurality of light sources, further wherein when the at least one photo detector receives the informational message from the portable electronic device, the controller actuates a subset of the plurality of light sources as directed by the informational message.

18. The system of claim 11, wherein the portable electronic device comprises a lens for concentrating received light upon an electronic device photo detector.

19. The system of claim 11, wherein the light emitting charger comprises a lens array disposed over the at least one light source.
